(19) United States
(12) Patent Application Publication
(10) Pub. No.: US 2006/0278047 A1
(43) Pub. Date: Dec. 14, 2006

(54) Multiple purpose plumbing tool

(76) Inventor: David Alan Thompson, Stanton, CA (US)

Correspondence Address: David Alan Thompson, Unit J, 8440 Cerritos Avenue, Stanton, CA, 90680, US

(21) Appl. No.: 11/147,945

(22) Filed: Jun. 8, 2005

(51) Int. Cl. B25B 13/00

(52) U.S. Cl. 81/124.4; 81/125.1

(57) ABSTRACT

The invention is a portable hand held plumbing tool designed for use in the installation, repairing, and servicing of plumbing fixtures. The invention contains a plurality of open-ended socket wrench heads which are joined via a hollow shaft which holds and stores a double sized driver. One of the socket wrench heads has slots which are used as a wrench, and to admit water supply lines and wing nut style connections. The invention also has a removable socket at one of the wrench heads.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE OR COMPUTER PROGRAM LISTING COMPACT DISC APPENDIX

Not Applicable.

### BACKGROUND OF THE INVENTION

1. Field of the Invention

The present invention relates to a multiple purpose hand tool for use in plumbing, especially around toilets and sinks.

The invention introduces a single tool that has all the fittings and adaptations necessary to perform most of the common functions required of a plumber or anyone Installing and or servicing a sink, toilet or other plumbing fixture connected to a plurality of water supply lines.

2. Description of Related Art

A search of prior art did not disclose any patents that read directly on the claims of the instant invention. However, the following U.S. patents are considered relevant:
1. The U.S. Pat. No. 5,005,451 to Lee et al discloses a hand tool that comprises an angle stop installation tool. This patent issued on Apr. 9, 1991.
2. The U.S. Pat. No. 6,016,728B1 to Hohl discloses a hand tool that that is multi-purpose and incorporates aspects of a crescent wrench and screwdriver. This patent issued on Jan. 25, 2000.
3. The U.S. Pat. No. 6,523,440B2 to Friedman et al discloses a compression stop and coupling wrench. This patent issued on Feb. 25, 2003.
4. The U.S. Pat. No. 5,996,447 to Bayouth et al discloses a sink wrench of hollow tubular design. This patent issued on Dec. 7, 1999.
5. The U.S. Pat. No. 6,474,201B1 to Lund discloses a tool for attaching and removing swivel fittings. This patent issued on Nov. 5, 2002.
6. The U.S. Pat. No. 6,698,317B1 to Machovsky describes a multi-purpose plumbing tool. This patent issued on Mar. 2, 2004.

For background purposes and as indicative of the art to which the invention is related, reference may be made to other cited patents.

### BRIEF SUMMARY OF THE INVENTION

The invention is a multiple purpose hand held tool. It is designed to work around toilets, sinks and other plumbing fixtures. It has elements of screwdrivers, an innovative removable socket and sockets with slots to accommodate a water supply line which also incorporates aspects of a wrench and can accommodate wing nuts, as are often installed on water supply line connections.

### BRIEF DESCRIPTION OF DRAWINGS

The invention will now be described, by way of example only, with reference to the accompanying drawings, as follows;

FIG. 1. Perspective top view of a preferred embodiment of the present invention.

FIG. 2. Side view of a preferred embodiment of the present invention, with multiple sized sockets and screwdriver attachment shown.

FIG. 3. Detail of a removable socket of the present invention.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, 3 structure or manner.

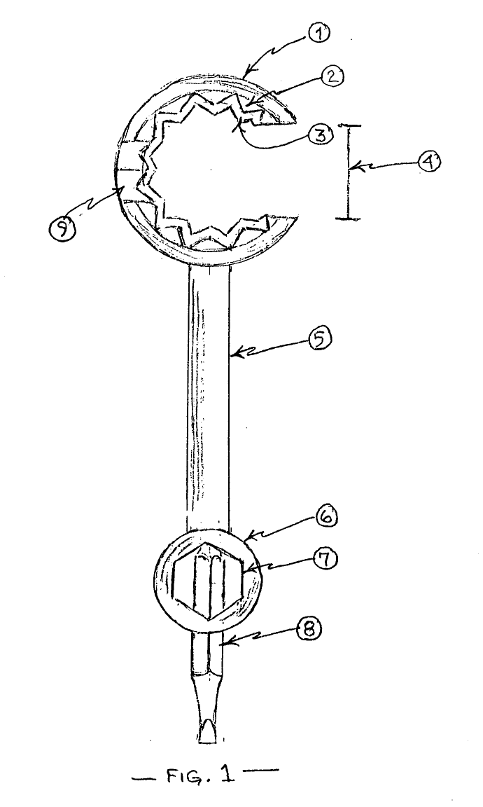

The invention is a multiple purpose hand held tool. It is designed for working around sinks, toilets and other plumbing fixtures. It has elements of screwdrivers, socket wrenches of various sizes, and an innovative removable socket and sockets with slots to accommodate another size wrench and wing nuts, as are often installed on water supply line connections. By using this tool, a person working on a plumbing fixture has virtually all the equipment they need in one handy instrument. The drawing of FIG. 1 represents a top view of the present invention which can be made of many types of metal and even plastic, the preferred metal being stainless steel. Demonstrated in FIG. 1 is the outer edge of the multiple socket head (1). The present invention in FIG. 1 shows two different size sockets (2) and (3). It has a slot wide enough to accommodate a water supply line (4). It has a hollow shaft that connects both socket heads and can accommodate a removable/reversible screwdriver tip (5). It has a removable socket (6) and (7). It has a removable screwdriver tip (8).

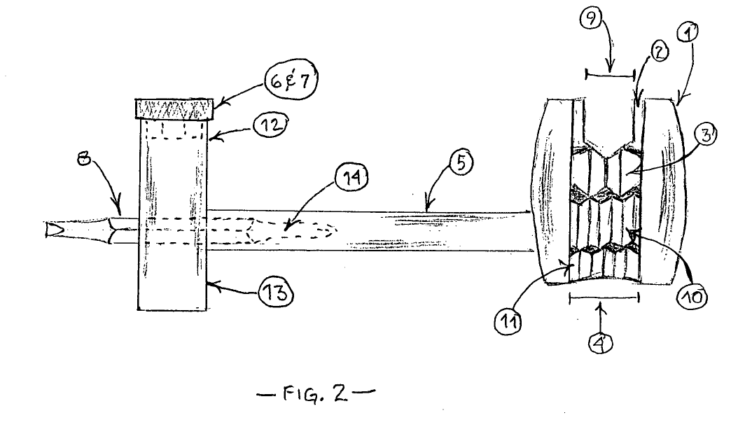

FIG. 2 shows the present invention from a side view. It has a slot that doubles as a wrench and can accommodate a water supply line wing nut (9). Shown are two more sizes at multiple socket head (10) and (11). It has an additional socket head with two more sizes (12) and (13). It has a phillips screwdriver tip (14). The multiple socket head with slots has a raised curved thicker area throughout its circumference (15) this thicker curved area has three functions. It makes the tool stronger and less prone to spreading when using it. It also makes the slot that doubles as a wrench (9) thicker which gives it more area for its use. This roundness also makes the tool fit and feel better in ones hand when using it.

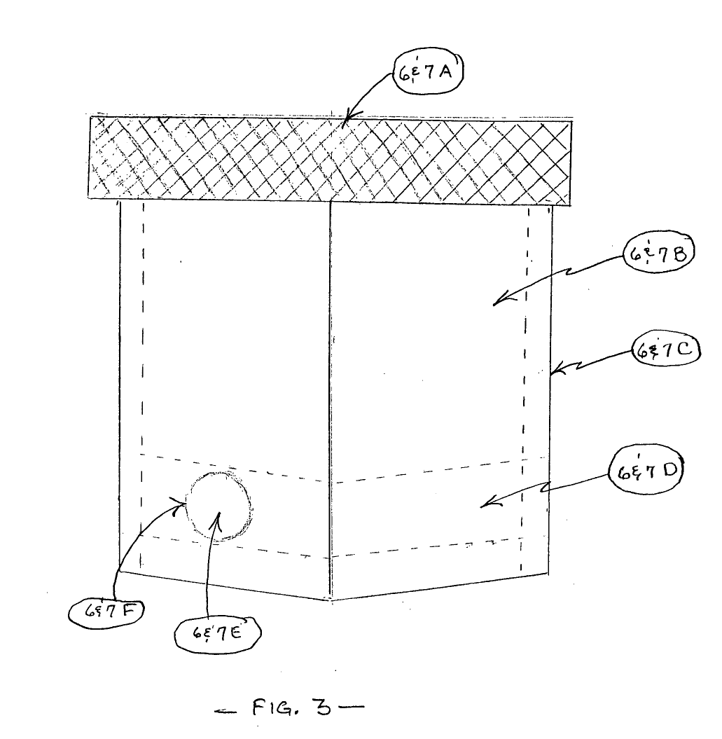

FIG. 3 shows the detail of removable socket (6) and (7). (6) and (7) A shows a raised knurled edge which aids in removing the socket. It is hex shaped to be able to fit into another socket (6) and (7) B and C. It incorporates a round hollow internal spring (6) and (7) D. This spring is designed to hold tension on retaining ball which holds socket into place (6) and (7) E and F.

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

I claim:

1. A multiple purpose hand tool, comprising:
a plurality of open-faced socket wrench heads;
a hollow shaft, connecting said socket wrench heads;
a removable socket and screwdriver tip.

2. The hand tool of claim I further comprising two driver heads with multiple sizes.

3. The hand tool of claim I wherein said shaft member has a hollow chamber for the storage of at least one spare driver head.

4. The hand tool of claim I, further comprising a removable socket.

5. The hand tool of claim I wherein at least one of said open-faced socket wrench heads comprises a double open-ended socket wrench head.

6. The hand tool of claim I wherein at least one of said open-faced socket wrench heads are notched at opposing sides of at least one face of said wrench head, said opening being of sufficient size to admit a wing nut on a water supply line.

7. The hand tool of claim I wherein at least one of said open-faced socket wrench heads is slotted, said slot aperture being of a sufficient size and width to admit a water supply line.

8. The hand tool of claim I wherein one of said open-faced socket wrench heads has a slot that doubles as a wrench on the face of said wrench head.

9. The hand tool of claim I wherein at least one of said open-faced socket wrench heads has a curved raised thicker area in the center of said wrench head that runs along said wrench head's entire circumference.
